(19) United States
(12) Patent Application Publication
(10) Pub. No.: US 2012/0284224 A1
(43) Pub. Date: Nov. 8, 2012

(54) BUILD OF WEBSITE KNOWLEDGE TABLES

(75) Inventors: Jun Yan, Beijing (CN); Lei Ji, Beijing (CN); Ning Liu, Beijing (CN); Zhimin Zhang, Beijing (CN); Zheng Chen, Beijing (CN)

(73) Assignee: Microsoft Corporation, Redmond, WA (US)

(21) Appl. No.: 13/100,305

(22) Filed: May 4, 2011

(51) Int. Cl. G06F 17/30

(52) U.S. Cl. 707/603; 707/E17.108

(57) ABSTRACT

Architecture that defines domain knowledge on networks, such as the Internet, as tables where each row is an entity in the target domain and each column is an attribute of these entities. The corresponding values for entity-attribute pairs are the domain knowledge. The architecture provides semi-automatic and systematic ways to extract network knowledge from at least an unstructured and semi-structured network (the Internet), structuralizes the knowledge in table format, and uses the domain tables to build the online updated knowledge base.

### BACKGROUND

Extracting domain knowledge from the networks such as the Internet is desirable for web applications such as web search and online advertising. However, existing techniques and interfaces do not provide a sufficient set of relevant results.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture defines domain knowledge on networks such as the Internet as tables where each row is an entity in the target domain and each column is an attribute of these entities. The corresponding values for entity-attribute pairs are the domain knowledge.

The architecture provides semi-automatic and systematic ways to extract network knowledge from at least an unstructured and semi-structured network (the Internet), structuralizes the knowledge in table format, and uses the domain tables to build the online updated knowledge base.

Three pipeline components are built to automatically extract domain entities, domain attributes and corresponding attribute values, respectively, from the unstructured and semi-structured network sites. The three components execute iteratively to enhance each other and conduct the online updating in a bootstrapping manner.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented knowledge system in accordance with the disclosed architecture.

FIG. 2 illustrates an alternative embodiment of a knowledge system that further employs knowledge extract and knowledge validation.

FIG. 3 illustrates an exemplary knowledge table interface.

FIG. 4 illustrates a general flow diagram of the processes employed for building a knowledge table.

FIG. 5 illustrates a more detailed algorithm for site detection of knowledge-containing websites.

FIG. 6 illustrates a process for knowledge extraction from a website.

FIG. 7 illustrates a process of multi-source knowledge fusion.

FIG. 8 illustrates a process for post-processing that seeks to fill vacant cells.

FIG. 9 illustrates a flow diagram for extracting knowledge in one view (either entity or attribute).

FIG. 10 illustrates a computer-implemented knowledge method in accordance with the disclosed architecture.

FIG. 11 illustrates further aspects of the method of FIG. 10.

FIG. 12 illustrates an alternative computer-implemented knowledge method in accordance with the disclosed architecture.

FIG. 13 illustrates further aspects of the method of FIG. 12.

FIG. 14 illustrates a block diagram of a computing system that executes knowledge base construction in accordance with the disclosed architecture.

### DETAILED DESCRIPTION

The disclosed architecture builds domain knowledge tables in an automatic and online updating manner, and provides one or more algorithms for extracting entities and attributes in a bootstrapping manner. The architecture includes at least three components: entity extraction, attribute extraction, and knowledge extraction (entity-attribute pair value extraction). The components execute iteratively in a bootstrapping way.

Domain definitions include entities such as “PhoneName1” or “PhoneName2”, which are entities in the target domain. Such entities can be seed entities of a “Cell phone” domain. With the seeds, entity extraction is employed to extract the entities. For the extracted entities, attribute extraction is employed to extract attributes for each entity. For example, the attributes of the cell phone entities can include “screen size”, “price”, “memory”, etc. When extracting attribute names, it can be the case to simultaneously extract one or more of the entity values as well. However, there are many entities where the attribute values cannot be extracted directly. Thus, a knowledge extraction process is employed to extract the attribute values, for example, for the vacant entity-attribute pairs.

After the knowledge information is obtained, it can be structured into some format that captures relationships such as a table format. The process repeats by going to the first component to again extract entities, with the new entities extracted and confirmed by the attributes. This procedure executes iteratively.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

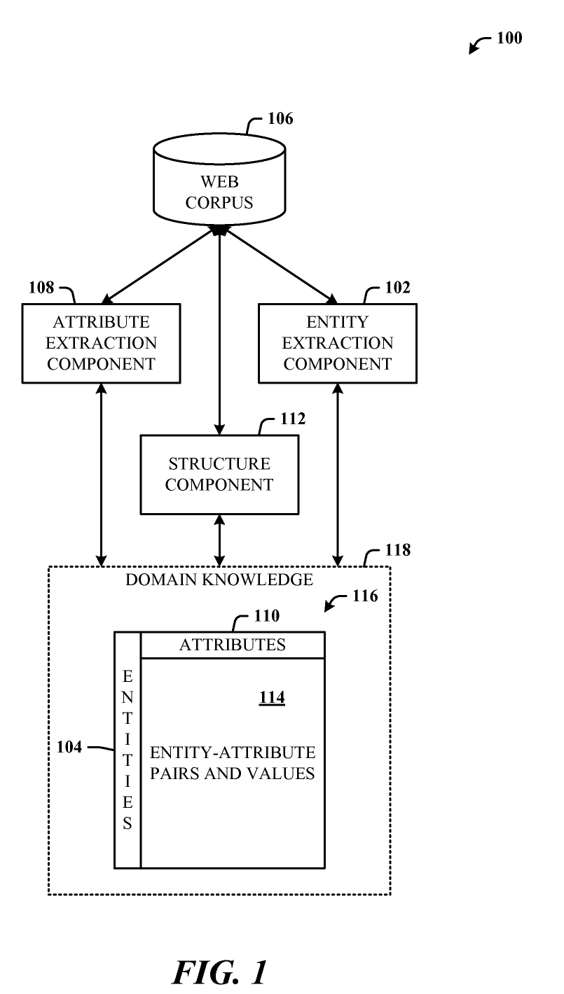

FIG. 1 illustrates a computer-implemented knowledge system 100 in accordance with the disclosed architecture. The system 100 includes an entity extraction component 102 that extracts entities 104 from a web corpus 106 based on entity seeds, an attribute extraction component 108 that extracts attributes 110 for the entities 104, and a structure component 112 that builds the entities 104, attributes 110 and, entity-attribute pairs and entity-attribute pair values 114 into a knowledge table 116 of domain knowledge 118.

The domain knowledge 118 is obtained from unstructured, semi-structured, and structured information of the web corpus 106, and the table 116 is employed to build and update an online knowledge base. The domain knowledge 118 is extracted from plain text documents that are parsed from webpages of the web corpus 106. The entities 104 and attributes 110 are extracted based on a query and query results of a search engine.

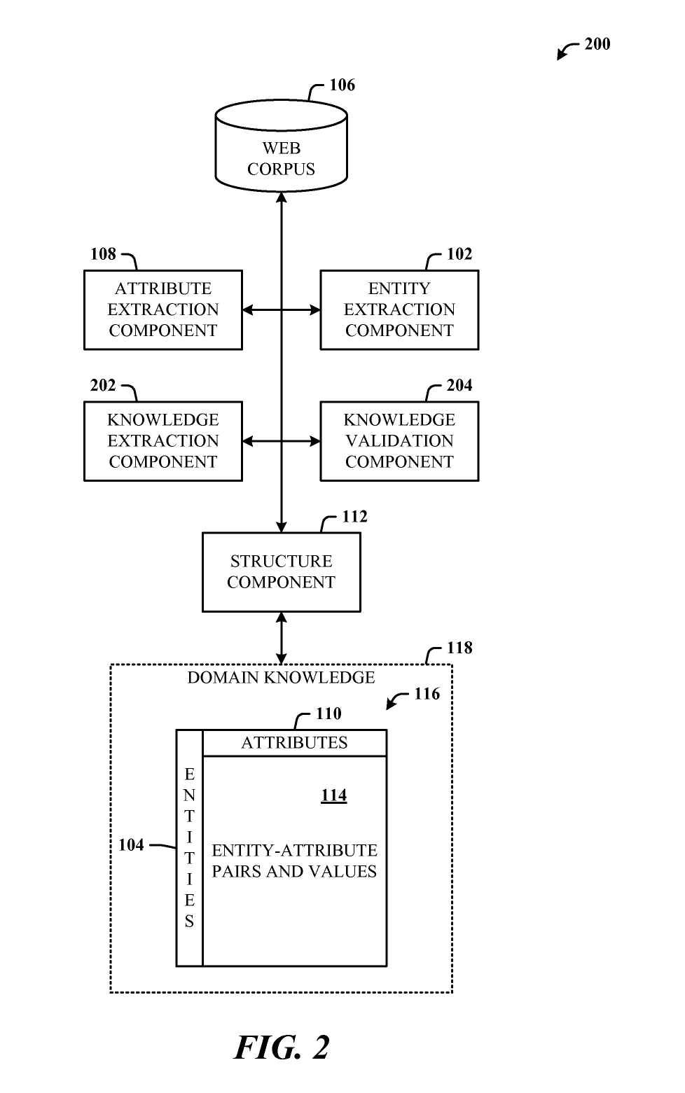

FIG. 2 illustrates an alternative embodiment of a knowledge system 200 that further employs knowledge extract and knowledge validation. In addition to the items and components of the knowledge system 100 of FIG. 1, the system 200 further can include a knowledge extraction component 202 that extracts values (e.g., attribute, entity) for vacant entity-attribute pairs, and a knowledge validation component that validates correctness of the domain knowledge 118 of the table 116.

The entity extraction component 102, attribute extraction component 108, knowledge extraction component 202, and structure component 112 execute iteratively to generate an updated knowledge table of domain knowledge. It is to be understood that the knowledge validation component 204 can also be included to execute iteratively with the above components as well, and in accordance with a bootstrap process.

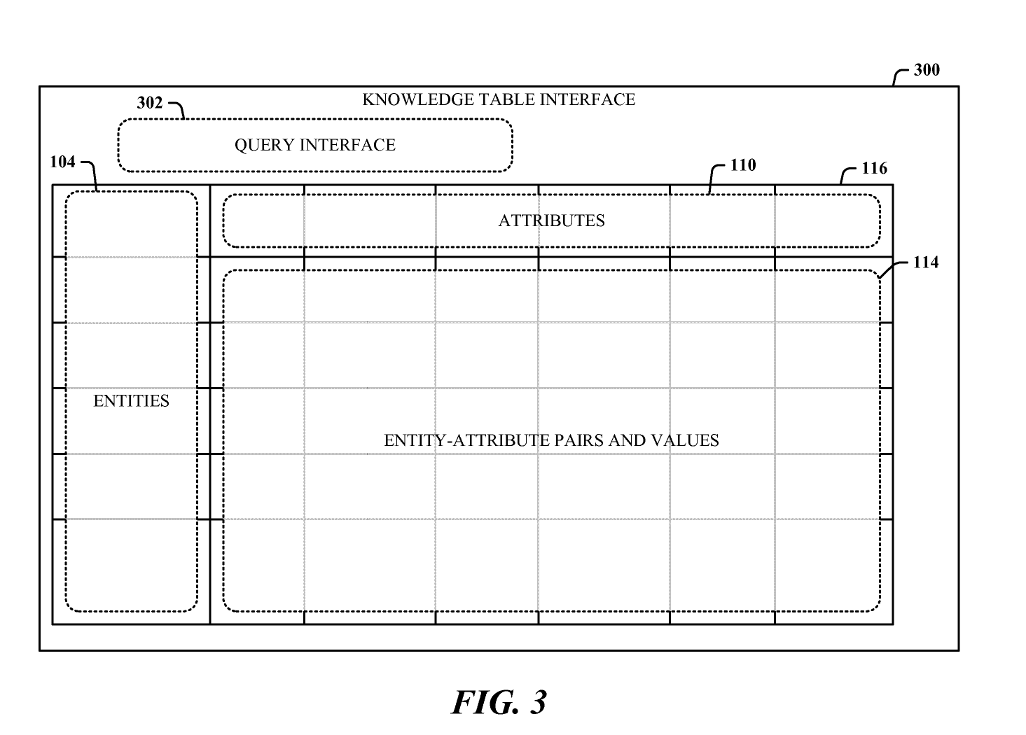

FIG. 3 illustrates an exemplary knowledge table interface 300. The interface 300 includes a query interface 302 into which a user enters a query for search results. The results are then restructured into the knowledge table 116 as values for the entity-attribute pairs 114. As shown, in the example, the entities 104 are presented as rows in the table 116, and the attributes 110 are presented as columns. Thus, each entity-attribute pair defines a cell in the table into which a value is inserted for presentation. As previously indicated, it can be the case where not all of the entity-attribute cells receive a value, since the attribute for the entity was not directly extractable. Thus, the knowledge extraction component then operates to find and return the value for the vacant entity-attribute cell.

The entities 104 can be listed under a row heading such as Item Names, for example, and the attributes can be associated with column headings such as Image, Description, Updated, Category, Screenshot, Prices, Version, Scores, Seller information, and so on. Thus, the user is presented with search results (from a query) having a variety of domain information to assist in describing the domain knowledge. Thus, if the query is “mobile app”, the domain knowledge returned and structured into the knowledge table 116 can be the different vendor applications, images, descriptions of each, updated date, and so on.

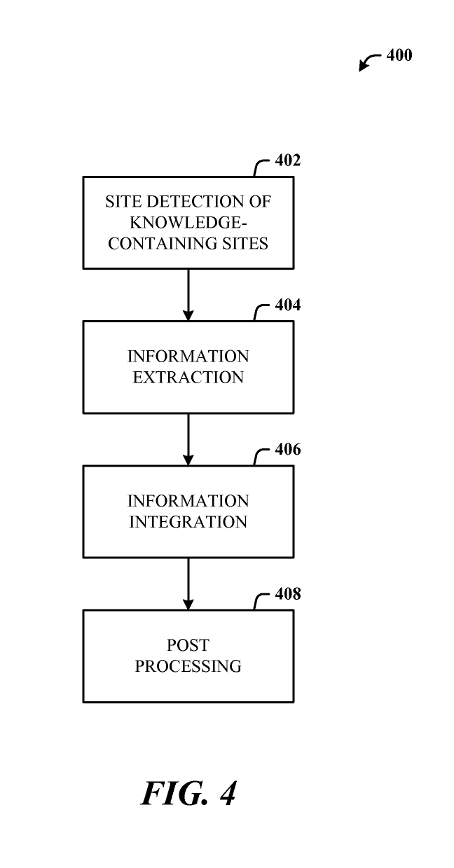

FIG. 4 illustrates a general flow diagram 400 of the processes employed for building a knowledge table. At 402, a site detection process is employed that detects knowledge-containing websites. This detection process can be accomplished using log-based solutions and/or page content-based solutions. At 404, information extraction is performed. This can be accomplished using intelligent site crawling or wrapper induction for page parsing, for example. At 406, information integration is performed. This can include entity integration and/or attribute integration. At 408, post processing is performed, which can include automatic table content filling and knowledge table querying interface development. Each of these processes will now be described in greater detail.

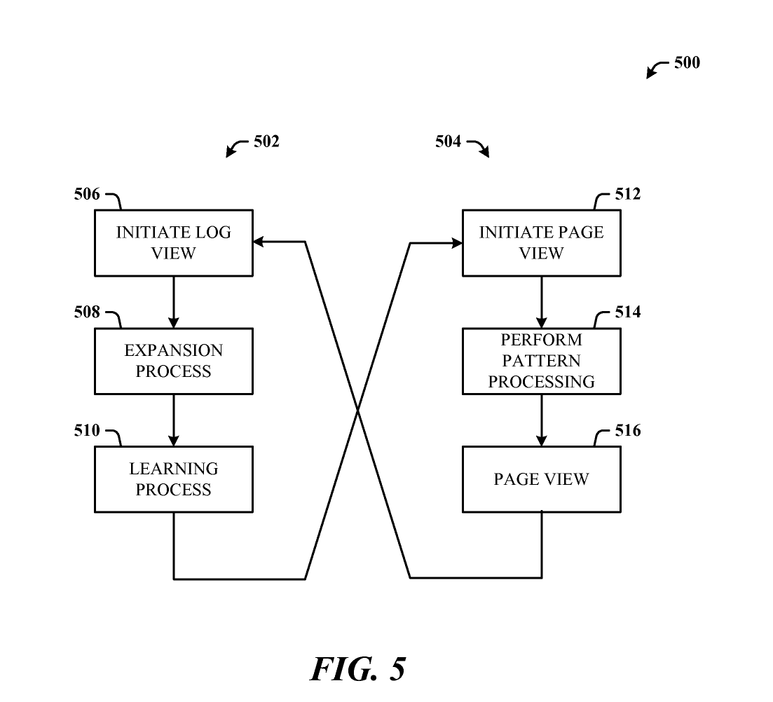

FIG. 5 illustrates a more detailed algorithm 500 for site detection of knowledge-containing websites. A goal is to obtain a ranked list of websites for knowledge extraction; however, it can be difficult to know which website contains the desired knowledge. The algorithm 500 employs co-training to find the knowledge-containing websites by way of the utilization of two views: a log view algorithm 502 and a page view algorithm 504. At 506, log view algorithm 502 is initiated. It is assumed that the webpages clicked by similar queries provide similar information to users. Thus, at 508, an expansion process performs a random walk to expand knowledge-containing websites from a manually provided seed. At 510, a learning process is performed to learn page/website patterns from expanded websites which are confidently determined to be knowledge-containing websites.

Flow is then to the page view algorithm 504 where page view is initiated at 512. It is assumed, in page view, that websites from which knowledge can be extracted generally follow some patterns. For example, a webpage that contains a table in the page and may also contain a term “screen-size” in the table as well. At 514, pattern processing is performed on an indexed collection of webpages and the appropriate webpages are selected. At 516, based on the pattern processing, knowledge-containing websites are confidently selected based on the patterns found. Flow is then back to the log view algorithm 502 to iterate the process for new information.

The log is the click-through log of the search engine. The log tracks and stores user behaviors such as the user views of queries, and thereafter, if the user uses the query in the search engine, kind of web page, and click-through values of the user, for example. If two websites are routinely clicked by the same group work of queries, it can be assumed that these two websites will provide similar information to the user, which also means the two websites will provide similar knowledge to the user.

The seeds can be website URLs (uniform resource locators). Consider that a user desires to find information about cell phones. The seed URLs can then be www.cellphonelcompany.com which can provide information about cellphone1 mobile phones, and www.cellphone2company.com provides some information about cellphone2 mobile phones. These websites can contain the knowledge desired to be extracted. Based on these seed websites, the queries that have clicks to these websites can be tracked. After identifying the queries that click to these websites, it can also be determined what kind of the other websites also clicked by these queries. Thus, based on this single iteration from the seed websites, additional websites can be identified that also possibly contain the knowledge desired based on the relationships, the queries, and the clicked websites.

However, the log view algorithm can also produce “noise” in that there may be irrelevant websites found in the iteration. For example, for some queries may be obtained by some random reason such as bias of the search engine (e.g., users clicked some websites that are not relevant to this query). Thus, the page view algorithm addresses this possibility of noise websites.

In the page view, all webpages indexed by the search engine are utilized, based on the assumption mentioned above, that websites containing the desired knowledge will exhibit patterns. For example, one pattern can be when interested in cell phones, relevant websites contain terms such as “cell phone”, the “mobile phone”, the product name such as “cellphone1” or “cellphone2”, company name such as “cellphone1company” and “cellphone2company”, etc. Based on the rules applied to look for these terms, for example, knowledge-containing websites can be identified.

Thus, the log view and the page view assist in finding knowledge-containing websites. Thus, generally, the seed website(s) is inserted and the log view algorithm 502 expands this more websites. The confidently-identified websites that contain the knowledge are then injected and utilized to identify new websites. This knowledge is then passed to the page view algorithm 504 to create new rules for identifying more websites. Any of the newly identified websites can then serve as the seed to the next iteration that begins in the log view algorithm 502.

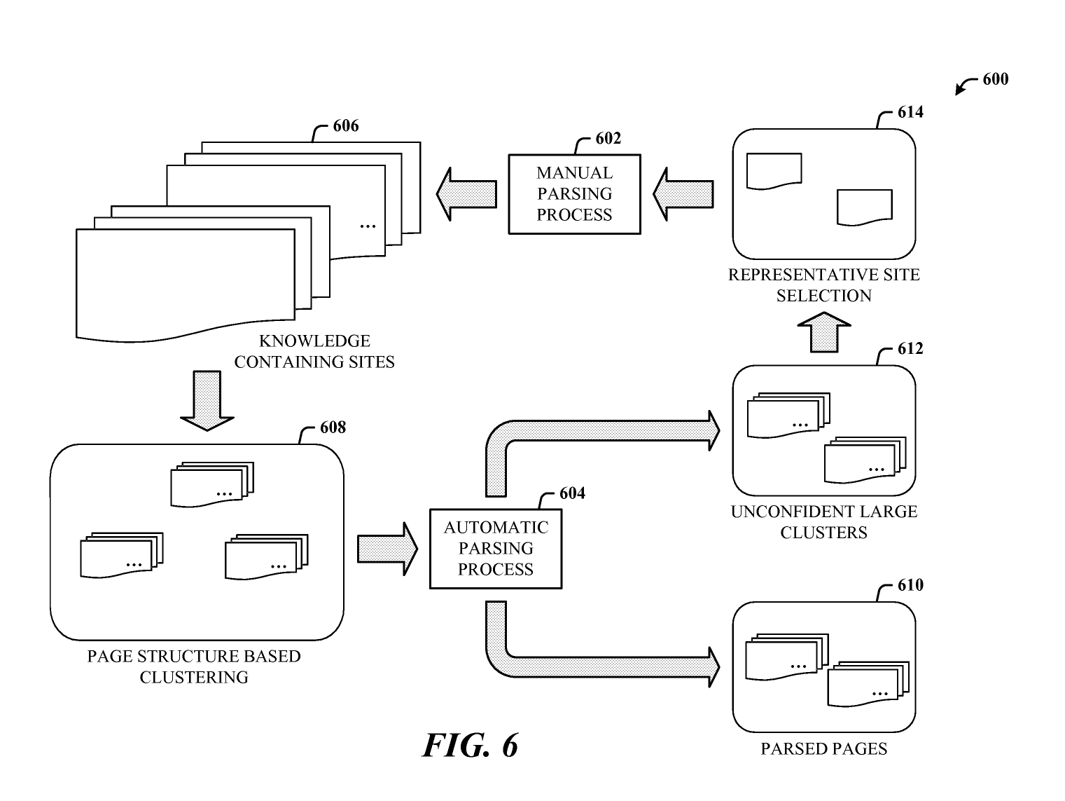

FIG. 6 illustrates a process 600 for knowledge extraction from a website. A goal is to crawl and parse target websites for knowledge extraction. A solution involves bootstrapping and active learning for website parsing. The process 600 comprises two integral parts: manual parsing process 602 and automatic parsing process 604. Given a collection of knowledge-containing sites obtained in the previous step, manual parsing process 602 utilizes one or more editors to understand the websites and then tag the website for blocks to extract. However, manual parsing can be time consuming since editors have to “touch” every webpage.

The automatic parsing process 604 can be auto-wrapper induction. A wrapper is a tool that extracts information from documents to use the information elsewhere. In the context of webpages, wrappers can be used to extract webpage information or content for product comparison or other purposes. Wrapper induction is a technique for automatically learning wrappers. Thus, by automatic wrapper induction, machine algorithms can automatically identify which block of a web page is more valuable for extracting the knowledge. However, auto-wrappers are limited with low recall and limited performance, and work only for a small set of the webpages. Thus, human editors are used as well to generate the knowledge-containing websites 606.

The process 600 for extracting knowledge from websites employs a clustering approach that groups webpages. Thus, after obtaining the knowledge-containing websites 606, these are clustered in a clustering process 608. After the webpage clustering process 608, clusters of websites are input to the auto-extraction process 604. The auto-parsing process 604 can only process a small set of the clusters. The output of the auto parsing process 604 is then a partial set of parsed webpages 610, and large unconfident clusters of webpages 612 are identified. The large clusters are those website clusters that contain more websites than other clusters. From the large clusters, half of the websites are selected for the manual parsing process 602 to be manually parsed by the human editors. This process 600 is then performed iteratively.

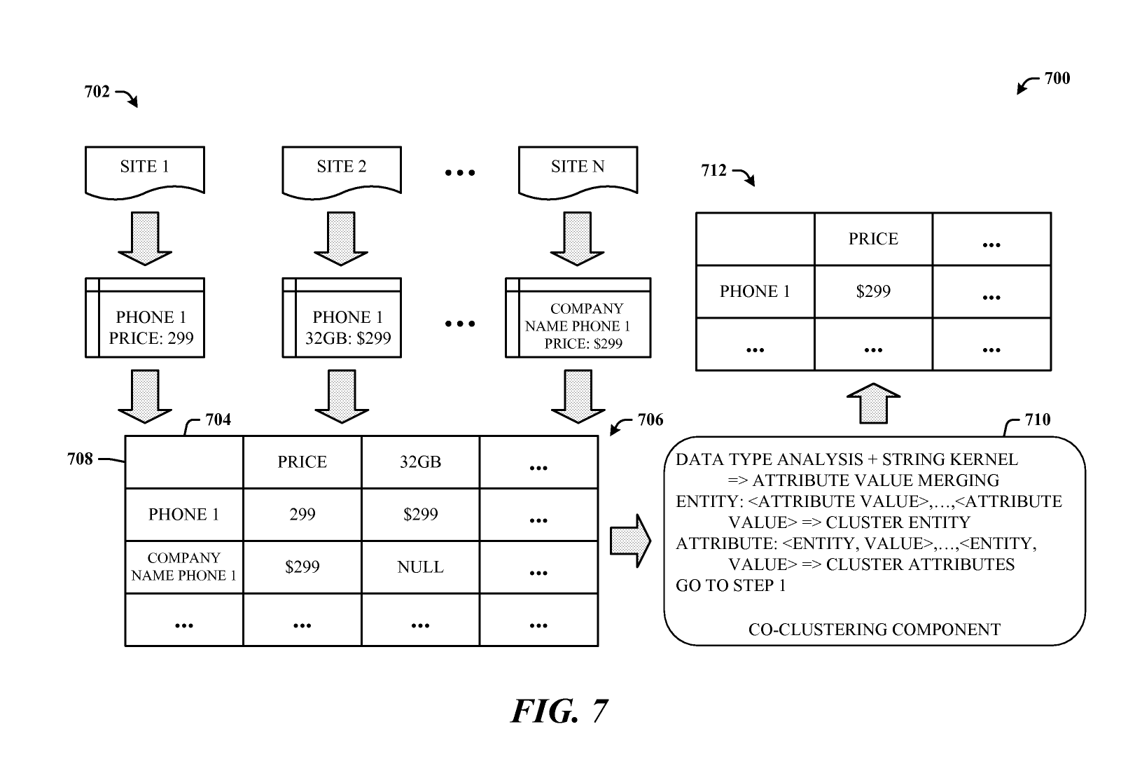

FIG. 7 illustrates a process 700 of multi-source knowledge fusion. Here, a set of knowledge-containing websites 702 have been selected. Extraction includes pulling entities and attributes from each of the websites 702. Entity information includes PHONE 1 and COMPANY NAME PHONE 1, which is represented in a column 704 of a table 706. Attributes such as price information (e.g., $299) and memory capability (e.g., 32 Gb) are represented in a top row 708 of the table 706. The entity-attribute pair cells then include values extracted from the site webpages. As shown, the table information is then processed through a co-clustering component 710 that operates to perform value merging for the entities and attributes to eliminate duplicate information. Thus, the resulting clustering information 712 shows simply the Phone 1 entity, price attribute, and entity-attribute value of $299.

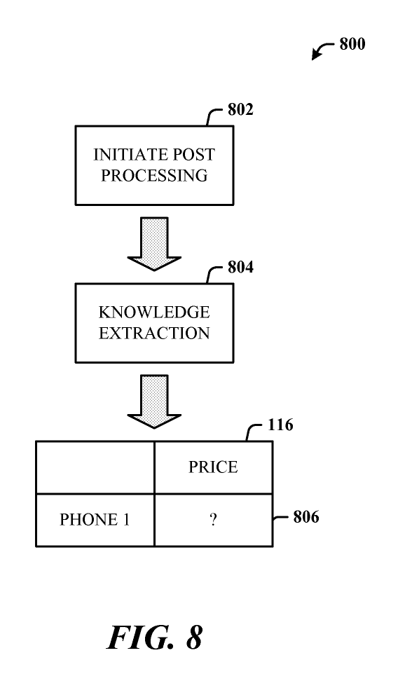

FIG. 8 illustrates a process 800 for post-processing that seeks to fill vacant cells. At 802, post processing is initiated. At 804, knowledge extraction is performed to attempt to fill-in vacant entity-attribute cell values such as a cell 806, in the knowledge table 116.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

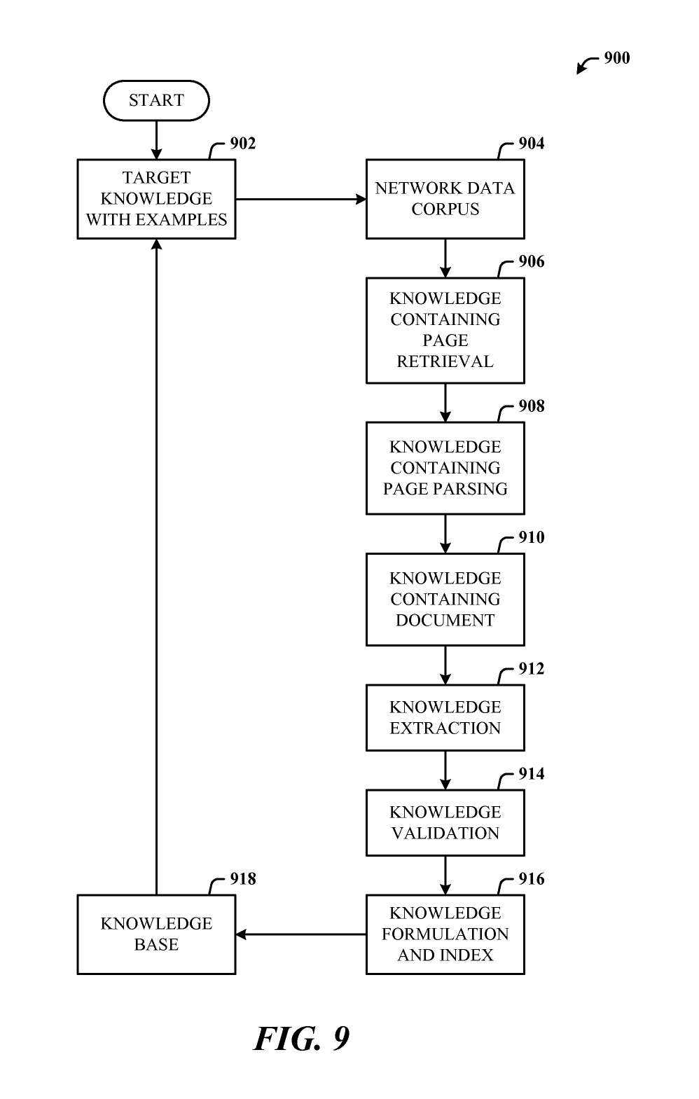

FIG. 9 illustrates a flow diagram 900 for extracting knowledge in one view (either entity or attribute). At 902, seed examples are selected to target knowledge. At 904, the seed examples are applied a data corpus to target knowledge. At 906, knowledge-containing webpages are retrieved. At 908, page parsing is performed on knowledge containing webpages. At 910, knowledge-containing documents are obtained. At 912, knowledge extraction is performed. At 914, knowledge validation is performed. At 916, knowledge formulation and indexing is performed. At 918, a knowledge based is created. Flow is then back to 902 to begin the next iteration using the knowledge base.

The entity and attribute extraction process follows the same flow chart. Firstly, using the seed example entities or attributes, from the web data corpus, knowledge-containing pages are retrieved through based on queries and the results from a search engine. In one specific implementation, a prefix tree solution can be used to automatically induce a wrapper for parsing the retrieved pages. Thus, the knowledge to be extracted is contained in plain text documents. The knowledge extraction component extracts the entities and/or attributes that are desired to be extracted. Then, a knowledge validation algorithm is employed to validate whether the knowledge extracted is correct. The confident knowledge that was extracted is then imported into the knowledge base. By way of bootstrapping, flow is back to the first step to again, conduct the knowledge extraction in a bootstrapping manner.

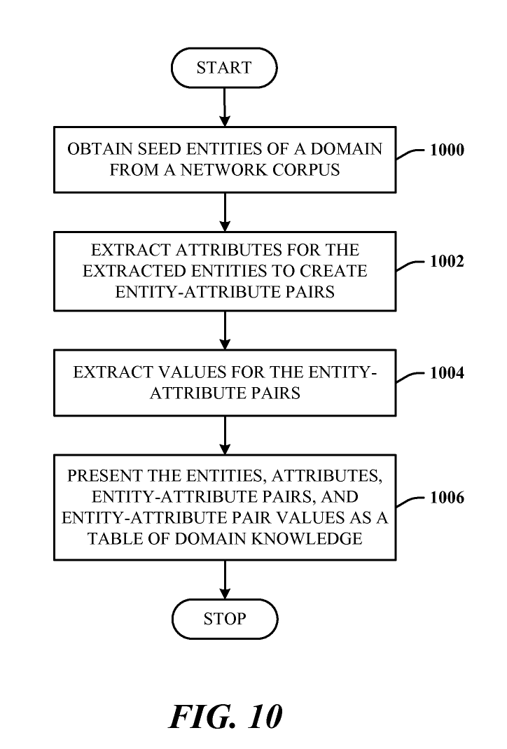

FIG. 10 illustrates a computer-implemented knowledge method in accordance with the disclosed architecture. At 1000, seed entities of a domain are obtained from a network corpus (e.g., a web corpus). At 1002, entities are extracted from the corpus based on the seed entities to obtain extracted entities. At 1004, attributes are extracted for the extracted entities to create entity-attribute pairs. At 1006, the entities, attributes, entity-attribute pairs, and entity-attribute pair values are presented as a table of domain knowledge.

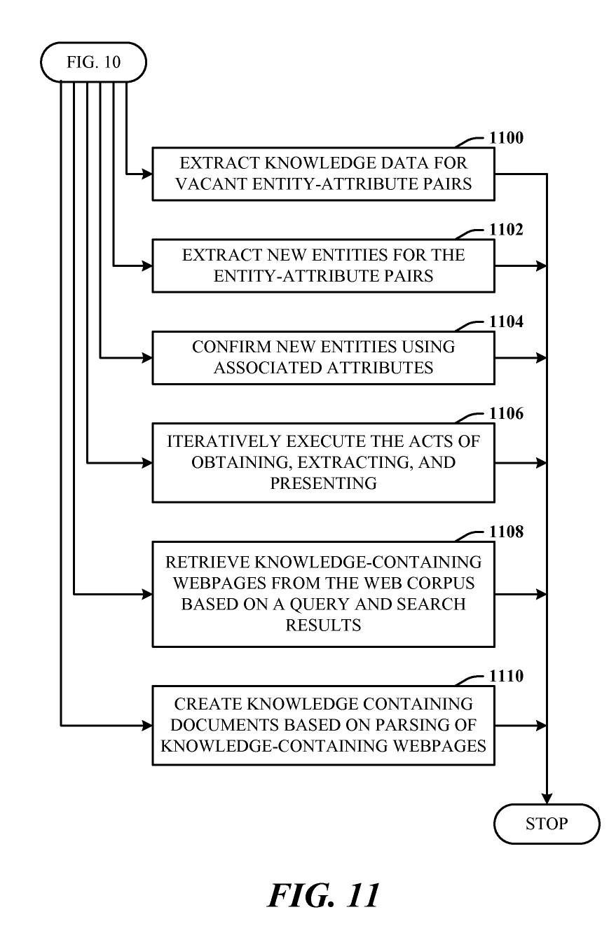

FIG. 11 illustrates further aspects of the method of FIG. 10. Note that the flow indicates that each block can represent a step that can be included, separately or in combination with other blocks, as additional aspects of the method represented by the flow chart of FIG. 10. At 1100, knowledge data is extracted for vacant entity-attribute pairs. At 1102, new entities are extracted for the entity-attribute pairs. At 1104, new entities are confirmed using associated attributes. At 1106, the acts of obtaining, extracting, and presenting are iteratively executed. At 1108, knowledge-containing webpages are retrieved from the web corpus based on a query and search results. At 1110, knowledge containing documents are created based on parsing of knowledge-containing webpages.

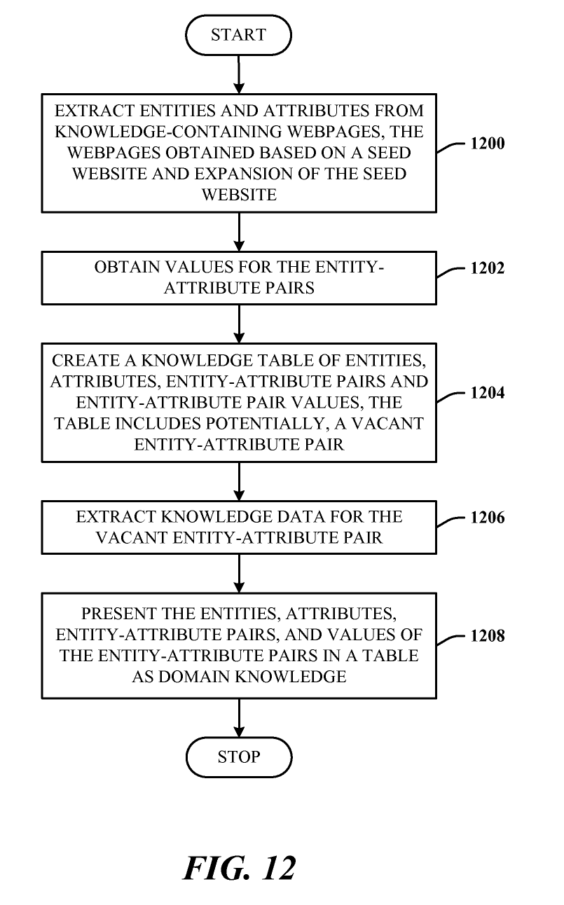

FIG. 12 illustrates an alternative computer-implemented knowledge method in accordance with the disclosed architecture. At 1200, entities and attributes are extracted from knowledge-containing webpages, the webpages obtained based on a seed website and expansion of the seed website. At 1202, values for the entity-attribute pairs are obtained. At 1204, a knowledge table of entities, attributes, entity-attribute pairs and entity-attribute pair values is created. The table includes potentially, a vacant entity-attribute pair. At 1206, knowledge data is extracted for the vacant entity-attribute pair. At 1208, the entities, attributes, entity-attribute pairs, and values of the entity-attribute pairs are presented in a table as domain knowledge.

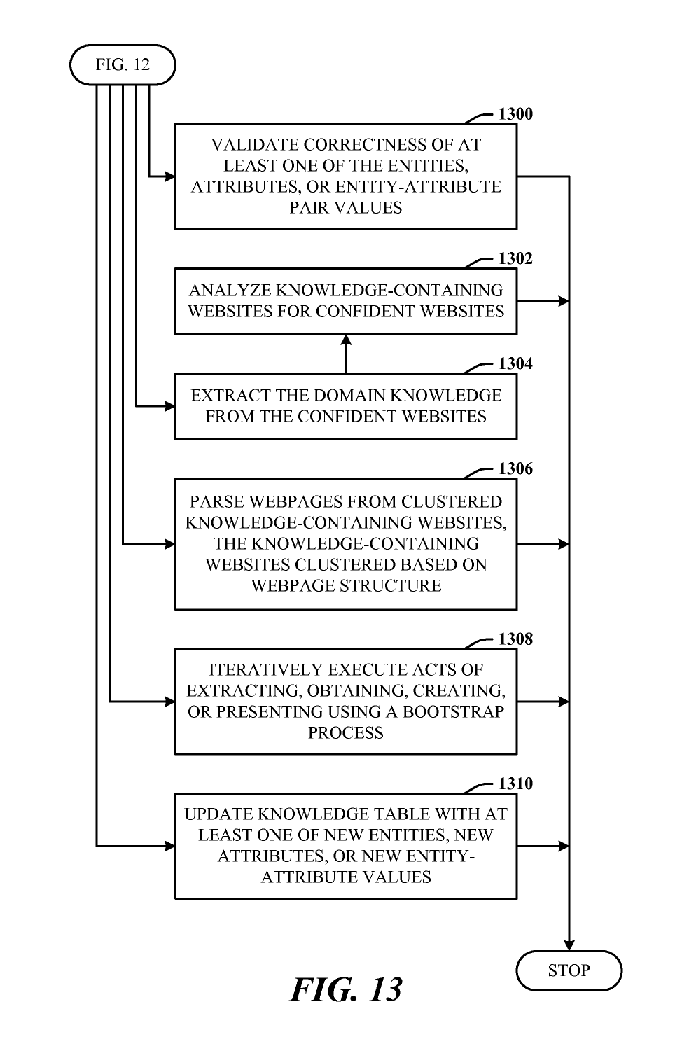

FIG. 13 illustrates further aspects of the method of FIG. 12. Note that the flow indicates that each block can represent a step that can be included, separately or in combination with other blocks, as additional aspects of the method represented by the flow chart of FIG. 12. At 1300, correctness of at least one of the entities, attributes, or entity-attribute pair values is validated. At 1302, knowledge-containing websites are analyzed for confident websites. At 1304, the domain knowledge is extracted from the confident websites. At 1306, webpages from clustered knowledge-containing websites are parsed. The knowledge-containing websites are clustered based on webpage structure. At 1308, the acts of extracting, obtaining, creating, and presenting are iteratively executed using a bootstrap process. At 1310, the knowledge table is updated with at least one of new entities, new attributes, or new entity-attribute values.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

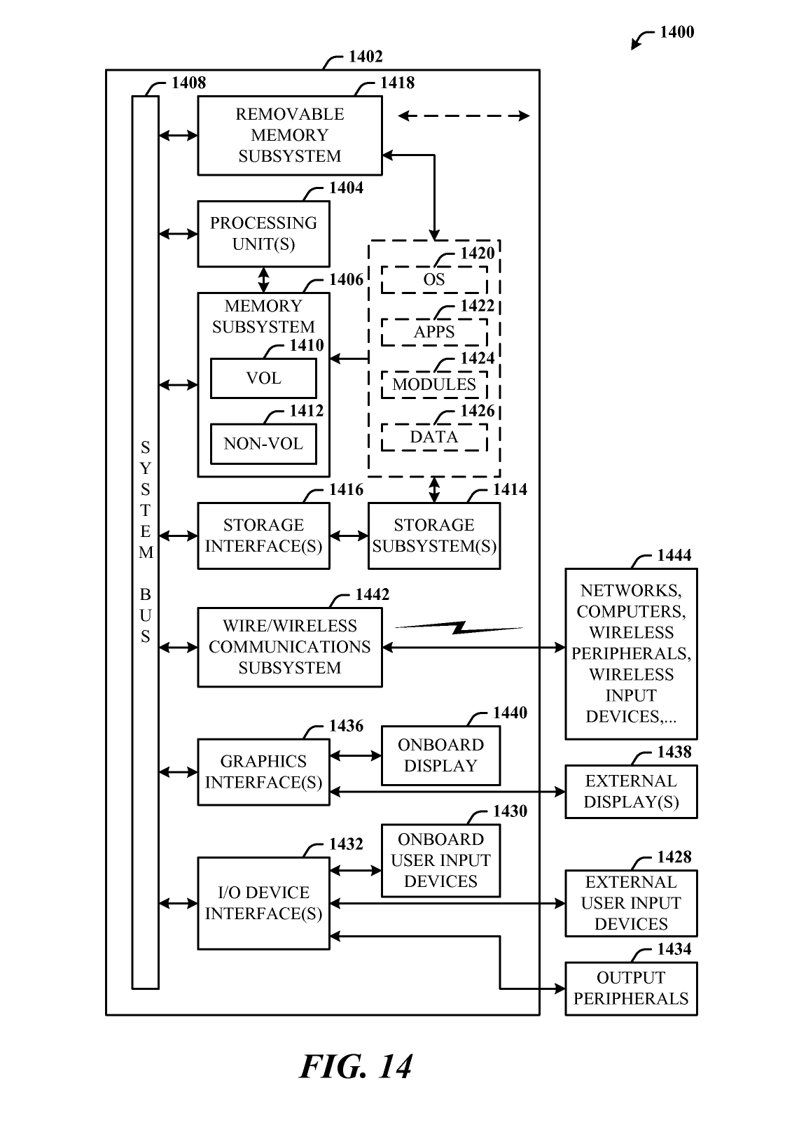

Referring now to FIG. 14, there is illustrated a block diagram of a computing system 1400 that executes knowledge base construction in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 14 and the following description are intended to provide a brief, general description of the suitable computing system 1400 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1400 for implementing various aspects includes the computer 1402 having processing unit(s) 1404, a computer-readable storage such as a system memory 1406, and a system bus 1408. The processing unit(s) 1404 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1406 can include computer-readable storage (physical storage media) such as a volatile (VOL) memory 1410 (e.g., random access memory (RAM)) and non-volatile memory (NON-VOL) 1412 (e.g., ROM, EPROM, EEPROM, etc.). A basic input/output system (BIOS) can be stored in the non-volatile memory 1412, and includes the basic routines that facilitate the communication of data and signals between components within the computer 1402, such as during startup. The volatile memory 1410 can also include a high-speed RAM such as static RAM for caching data.

The system bus 1408 provides an interface for system components including, but not limited to, the system memory 1406 to the processing unit(s) 1404. The system bus 1408 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1402 further includes machine readable storage subsystem(s) 1414 and storage interface(s) 1416 for interfacing the storage subsystem(s) 1414 to the system bus 1408 and other desired computer components. The storage subsystem(s) 1414 (physical storage media) can include one or more of a hard disk drive (HDD), a magnetic floppy disk drive (FDD), and/or optical disk storage drive (e.g., a CD-ROM drive DVD drive), for example. The storage interface(s) 1416 can include interface technologies such as EIDE, ATA, SATA, and IEEE 1394, for example.

One or more programs and data can be stored in the memory subsystem 1406, a machine readable and removable memory subsystem 1418 (e.g., flash drive form factor technology), and/or the storage subsystem(s) 1414 (e.g., optical, magnetic, solid state), including an operating system 1420, one or more application programs 1422, other program modules 1424, and program data 1426.

The operating system 1420, one or more application programs 1422, other program modules 1424, and/or program data 1426 can include the entities and components of the system 100 of FIG. 1, the entities and components of the system 200 of FIG. 2, the knowledge interface 300 of FIG. 3, the flow diagram 400 of FIG. 4, the algorithm 500 of FIG. 5, the processes of FIG. 6-8, the flow diagram of FIG. 9, and the methods represented by the flow charts of FIGS. 10-13, for example.

Generally, programs include routines, methods, data structures, other software components, etc., that perform particular tasks or implement particular abstract data types. All or portions of the operating system 1420, applications 1422, modules 1424, and/or data 1426 can also be cached in memory such as the volatile memory 1410, for example. It is to be appreciated that the disclosed architecture can be implemented with various commercially available operating systems or combinations of operating systems (e.g., as virtual machines).

The storage subsystem(s) 1414 and memory subsystems (1406 and 1418) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 1402 and includes volatile and non-volatile internal and/or external media that is removable or non-removable. For the computer 1402, the media accommodate the storage of data in any suitable digital format. It is to be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1402, programs, and data using external user input devices 1428 such as a keyboard and a mouse. Other external user input devices 1428 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1402, programs, and data using onboard user input devices 1430 such a touchpad, microphone, keyboard, etc., where the computer 1402 is a portable computer, for example. These and other input devices are connected to the processing unit(s) 1404 through input/output (I/O) device interface(s) 1432 via the system bus 1408, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1432 also facilitate the use of output peripherals 1434 such as printers, audio devices, camera devices, and so on, such as a sound card and/or onboard audio processing capability.

One or more graphics interface(s) 1436 (also commonly referred to as a graphics processing unit (GPU)) provide graphics and video signals between the computer 1402 and external display(s) 1438 (e.g., LCD, plasma) and/or onboard displays 1440 (e.g., for portable computer). The graphics interface(s) 1436 can also be manufactured as part of the computer system board.

The computer 1402 can operate in a networked environment (e.g., IP-based) using logical connections via a wired/wireless communications subsystem 1442 to one or more networks and/or other computers. The other computers can include workstations, servers, routers, personal computers, microprocessor-based entertainment appliances, peer devices or other common network nodes, and typically include many or all of the elements described relative to the computer 1402. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1402 connects to the network via a wired/wireless communication subsystem 1442 (e.g., a network interface adapter, onboard transceiver subsystem, etc.) to communicate with wired/wireless networks, wired/wireless printers, wired/wireless input devices 1444, and so on. The computer 1402 can include a modem or other means for establishing communications over the network. In a networked environment, programs and data relative to the computer 1402 can be stored in the remote memory/storage device, as is associated with a distributed system. It will be appreciated that the network connections shown are exemplary and other means of establishing a communications link between the computers can be used.

The computer 1402 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented knowledge system, comprising:
an entity extraction component that extracts entities from a web corpus based on entity seeds;
an attribute extraction component that extracts attributes for the entities;
a structure component that builds the entities, attributes, and entity-attribute pairs, and entity-attribute pair values into a knowledge table of domain knowledge; and
a processor that executes computer-executable instructions associated with at least the entity extraction component, attribute extraction component, or the structure component.

2. The system of claim 1, further comprising a knowledge extraction component that extracts values for vacant entity-attribute pairs.

3. The system of claim 2, wherein the entity extraction component, attribute extraction component, knowledge extraction component, and structure component execute iteratively to generate an updated knowledge table of domain knowledge.

4. The system of claim 1, further comprising a validation component that validates correctness of domain knowledge of the table.

5. The system of claim 1, wherein the domain knowledge is obtained from unstructured, semi-structured, and structured information of the web corpus, and the table is employed to build and update an online knowledge base.

6. The system of claim 1, wherein the domain knowledge is extracted from plain text documents that are parsed from webpages.

7. The system of claim 1, wherein the entities and attributes are extracted based on a query and query results of a search engine.

8. A computer-implemented knowledge method, comprising acts of:
obtaining seed entities of a domain from a network corpus;
extracting entities from the corpus based on the seed entities to obtain extracted entities;
extracting attributes for the extracted entities to create entity-attribute pairs;
extracting values for the entity-attribute pairs;
presenting the entities, attributes, entity-attribute pairs, and entity-attribute pair values as a table of domain knowledge; and
utilizing a processor that executes instructions stored in memory to perform at least one of the acts of obtaining, extracting, or presenting.

9. The method of claim 8, further comprising extracting knowledge data for vacant entity-attribute pairs.

10. The method of claim 8, further comprising extracting new entities for the entity-attribute pairs.

11. The method of claim 8, further comprising confirming new entities using associated attributes.

12. The method of claim 8, further comprising iteratively executing the acts of obtaining, extracting, and presenting.

13. The method of claim 8, further comprising retrieving knowledge-containing webpages from the web corpus based on a query and search results.

14. The method of claim 8, further comprising creating knowledge containing documents based on parsing of knowledge-containing webpages.

15. A computer-implemented knowledge method, comprising acts of:
extracting entities and attributes from knowledge-containing webpages, the webpages obtained based on a seed website and expansion of the seed website;
obtaining values for the entity-attribute pairs;
creating a knowledge table of entities, attributes, entity-attribute pairs and entity-attribute pair values, the table includes potentially, a vacant entity-attribute pair;
extracting knowledge data for the vacant entity-attribute pair;
presenting the entities, attributes, entity-attribute pairs, and values of the entity-attribute pairs in a table as domain knowledge; and
utilizing a processor that executes instructions stored in memory to perform at least one of the acts of extracting, obtaining, creating, or presenting.

16. The method of claim 15, further comprising validating correctness of at least one of the entities, attributes, or entity-attribute pair values.

17. The method of claim 15, further comprising:
analyzing knowledge-containing websites for confident websites; and
extracting the domain knowledge from the confident websites.

18. The method of claim 15, further comprising parsing webpages from clustered knowledge-containing websites, the knowledge-containing websites clustered based on webpage structure.

19. The method of claim 15, further comprising iteratively executing the acts of extracting, obtaining, creating, and presenting using a bootstrap process.

20. The method of claim 15, further comprising updating the knowledge table with at least one of new entities, new attributes, or new entity-attribute values.
